(19) United States
(12) Patent Application Publication
(10) Pub. No.: US 2015/0271822 A1
(43) Pub. Date: Sep. 24, 2015

(54) SYSTEMS, APPARATUS AND METHODS FOR IMPROVING SYSTEM ACQUISITION PERFORMANCE IN MULTI-SIM WIRELESS DEVICES

(71) Applicant: QUALCOMM INCORPORATED, San Diego, CA (US)

(72) Inventors: Bhaskara Viswanadham Batchu, Medak (IN); Stanley Suyi Tsai, Frederick, CO (US); Pravir Kumar, Purnea (IN)

(73) Assignee: QUALCOMM INCORPORATED, San Diego, CA (US)

(21) Appl. No.: 14/220,593

(22) Filed: Mar. 20, 2014

(51) Int. Cl. H04W 72/04; H04B 1/3816; H04W 24/02

(52) U.S. Cl. CPC H04W 72/0453; H04W 24/02; H04B 1/3816

(57) ABSTRACT

Methods and apparatus for improving system acquisition performance in multi-SIM devices are provided. In one aspect, a method of acquiring a signal comprises defining a size of a frequency bin for a first radio access technology based on a frequency error for a second radio access technology. The method further includes determining that the signal is not acquirable using the defined size for a predetermined number of consecutive acquisition attempts. The method further includes adjusting the size of the frequency bin based on the determining. The method further includes determining whether the signal is not acquirable using the adjusted size. In one implementation, the method further includes identifying the frequency error for the second radio access technology. In one implementation, the adjusting the size of the frequency bin comprises disregarding the frequency error for the second radio access technology. In one implementation the adjusting the size of the frequency bin is based on a most recently received frequency error for the first radio access technology.

### BACKGROUND

1. Field

Certain aspects of the present disclosure generally relate to wireless communications, and more particularly, to systems, apparatus and methods for improving system acquisition performance in multi-SIM wireless devices.

2. Background

Mobile devices compatible with two or more radio access technologies (RATs) may contend with differing frequency errors between the two or more RATs. An active RAT reports rotator frequency error to a common manager module in the mobile device's modem or modem software, e.g., sometimes called a TCXOMGR. The module manages frequency errors reported by all active RATs in the mobile device. The most recent good rotator frequency error reported to the manager module by a RAT is called the recent good system (RGS). A RAT fetches the RGS in the form of a seed frequency and an uncertainty value for that seed frequency and determines a frequency bin, i.e., a frequency window, based on the uncertainty and looks for energy in the determined frequency window around the seed frequency. Because the RGS generally has a small uncertainty, if available, system RGS information is conventionally always used by a RAT to acquire or search for energies using small frequency bins. Accordingly, where RGS information is available, a RAT never searches for energy in frequency bins larger than that indicated by the RGS information irrespective of a number of acquisition failures. If RGS information isn't available, the manager module returns frequency information with a larger, less accurate uncertainty value, necessitating the use of larger frequency bins for system acquisition which inherently take more time to acquire.

However, the manager module does not track or indicate which RAT last updated the RGS value. Thus, where the RGS value is updated by a first RAT, the updated RGS value may indicate inaccurate frequency information for acquiring a system utilizing a second RAT if the frequency error for the first RAT is sufficiently different from the frequency error for the second RAT. However, the second RAT will operate under the assumption that the RGS information is accurate and will attempt to acquire the system by searching for energy in small frequency bins indicated by the inaccurate RGS information. Where the frequency error between the first and second RATs is sufficiently different, the RGS information may incorrectly indicate that the system is operating at a frequency located in a frequency bin other than the actual frequency bin, and the second RAT may be unable to acquire the system and the second RAT will remain out of service despite having sufficient channel energies. As such, systems, apparatus and methods are needed for improving system acquisition performance in multi-SIM wireless devices.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method for acquiring a signal. The method comprises defining a size of a frequency bin for a first radio access technology based on a frequency error for a second radio access technology. The method further comprises determining that the signal is not acquirable using the defined size for a predetermined number of consecutive acquisition attempts. The method further comprises adjusting the size of the frequency bin based on the determining. The method further comprises determining whether the signal is not acquirable using the adjusted size.

Another aspect of the disclosure provides an apparatus for wireless communication. The apparatus comprises a processor configured to define a size of a frequency bin for a first radio access technology based on a frequency error for a second radio access technology. The processor is further configured to determine that the signal is not acquirable using the defined size for a predetermined number of consecutive acquisition attempts. The processor is further configured to adjust the size of the frequency bin based on the determining. The processor is further configured to determine whether the signal is not acquirable using the adjusted size.

Another aspect of the disclosure provides a non-transitory computer-readable medium comprising code. The code, when executed, causes a processor to define a size of a frequency bin for a first radio access technology based on a frequency error for a second radio access technology. The code further causes the processor to determine that the signal is not acquirable using the defined size for a predetermined number of consecutive acquisition attempts. The code further causes the processor to adjust the size of the frequency bin based on the determining. The code further causes the processor to determine whether the signal is not acquirable using the adjusted size.

Another aspect of the disclosure provides an apparatus for wireless communication. The apparatus comprises means for defining a size of a frequency bin for a first radio access technology based on a frequency error for a second radio access technology. The apparatus further comprises means for determining that the signal is not acquirable using the defined size for a predetermined number of consecutive acquisition attempts. The apparatus further comprises means for adjusting the size of the frequency bin based on the determining. The apparatus further comprises means for determining whether the signal is not acquirable using the adjusted size.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 is a flowchart of an aspect of an exemplary method for acquiring a signal, according to one implementation.

FIG. 4 is another flowchart of an aspect of the exemplary method of FIG. 3 for acquiring a signal, according to one implementation.

FIG. 5 is a functional block diagram of an exemplary apparatus for wireless communication, according to another implementation.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In some aspects, wireless signals may be transmitted utilizing various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to a different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

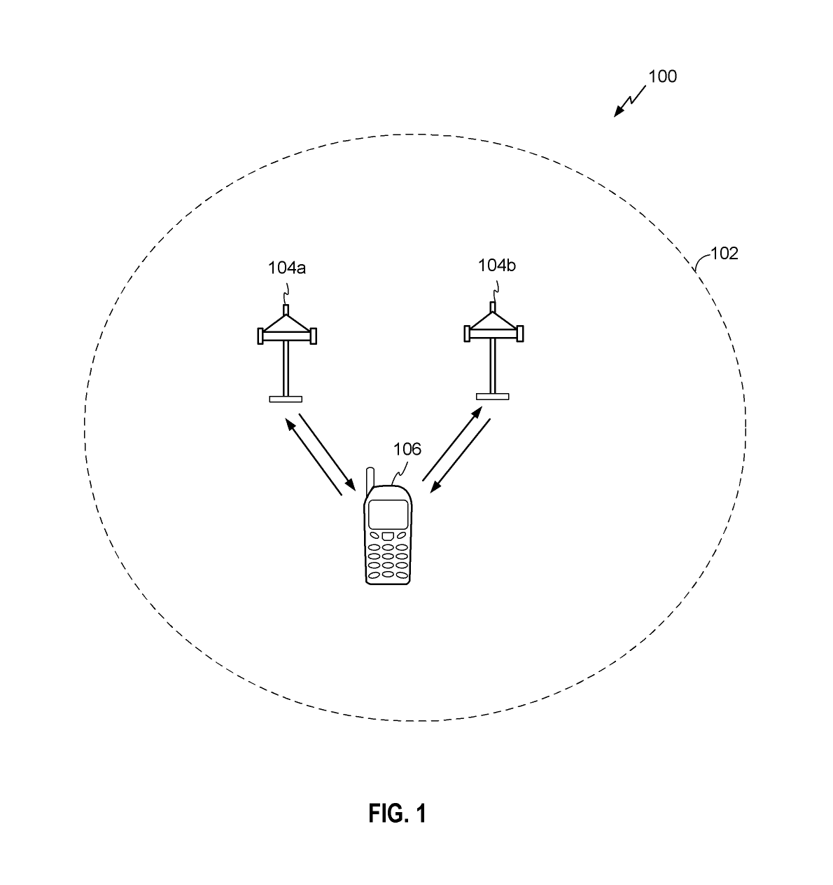

FIG. 1 illustrates an example of a wireless communication network or system 100 in which aspects of the present disclosure may be employed. The wireless communication system 100 may include access points (APs) 104a and 104b as well as a user device or station (STA) 106, for example. In some implementations, the AP 104a may operate according to a first radio access technology (RAT) and the AP 104b may operate according to a second RAT. The STA may be configured to communicate with either or both of the APs 104a and 104b utilizing either or both of the first RAT and the second RAT, respectively. Thus, APs 104a and 104b may be configured as base stations and provide wireless communication coverage in basic service area (BSA) 102. Depending on the technology considered, a BSA can sometimes be called coverage area, cell, etc. The APs 104a and 104b along with the STA 106 may be referred to as a basic service set (BSS). As shown in FIG. 1, multiple APs may provide different BSAs to the same device. For example, STA 106 may receive service from both AP 104a and AP 104b.

The present application contemplates a simple and robust protocol by which a RAT may acquire the system even if the frequency error information (e.g., the RGS) becomes inaccurate through previous update from another RAT. In some implementations, the protocol may include a mechanism by which a common manager module (e.g., a TXCOMGR) within the STA 106 may disregard the RGS after a certain number of acquisition failures utilizing the RGS. The manager module may instead utilize a fallback RGS or factory mode indicating larger frequency bins to be utilized for acquiring the system despite having access to the actual RGS error information. Such a protocol would enable improved acquisition of the associated wireless networks. For example, larger frequency bins would only be utilized when utilization of the smaller frequency bins is insufficient to acquire the system, thus both increasing the likelihood of system acquisition while simultaneously limiting the increase in the average length of time required to acquire the system inherent in utilizing larger frequency bins.

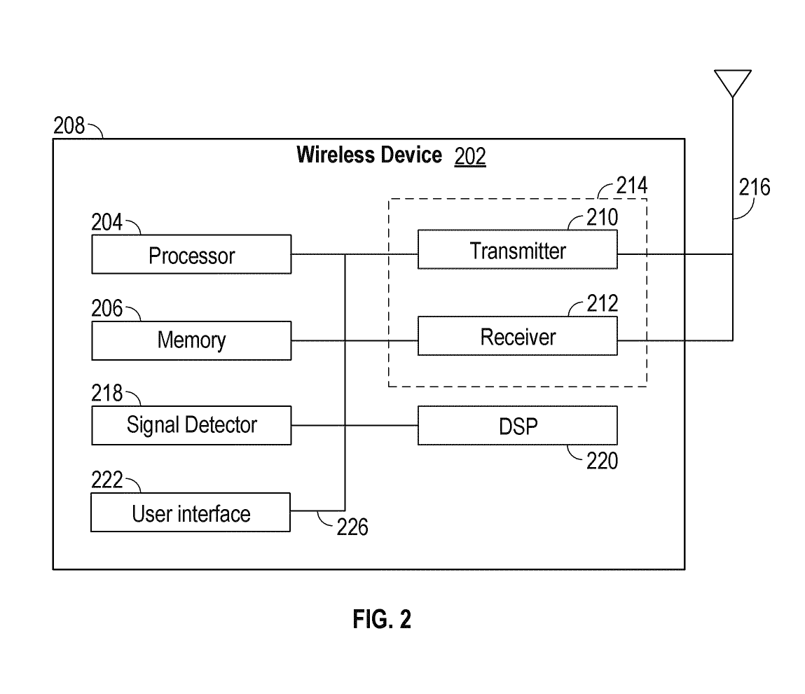

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise one of the APs 104a or 104b or the STA 106.

The wireless device 202 may include a processor 204 which controls operation of the wireless device 202. The processor 204 may also be referred to as a central processing unit (CPU) or hardware processor and may comprise the common managing module (e.g., the TCXOMGR) described above in connection with FIG. 1 alone or in combination with memory 206. The memory 206 may include both read-only memory (ROM) and random access memory (RAM) and may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas, which may be utilized during MIMO communications, for example.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

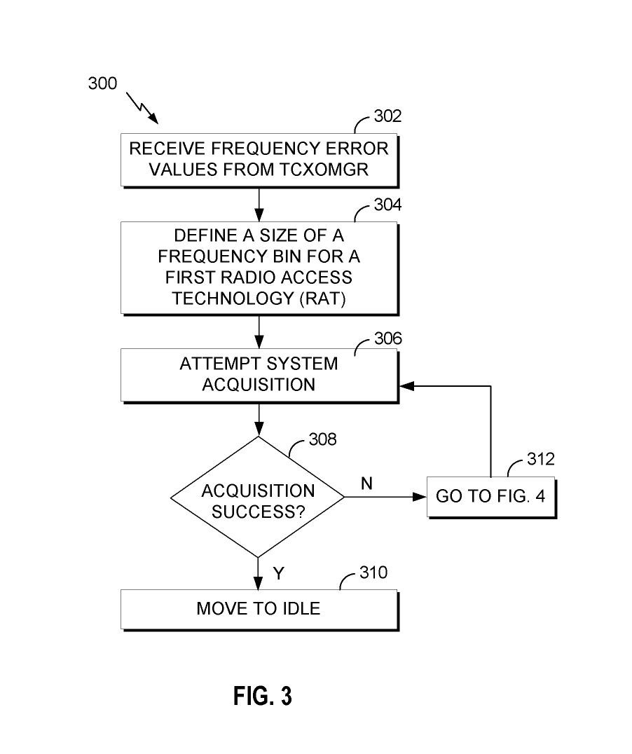

FIG. 3 is a flowchart of an aspect of an exemplary method for acquiring a signal, according to one implementation. The wireless device 202 shown in FIG. 2 may represent a more detailed view of the STA 106, as described above. Thus, in one implementation, one or more of the blocks in flowchart 300 may be performed by, or in connection with, a processor, such as the processor 204 of FIG. 2, although those having ordinary skill in the art will appreciate that other components may be used to implement one or more of the blocks described herein. Although blocks may be described as occurring in a certain order, the blocks can be reordered, blocks can be omitted, and/or additional blocks can be added.

One or more methods described in connection with FIG. 3 provide a failsafe method by which a RAT can acquire a network connection even if the RGS frequency information from the TCXOMGR becomes inaccurate. The RGS information may become inaccurate in any of several ways including but not limited to network problems, frequency offset issues between different RATs and accidental changes in XO trim. FIG. 3 introduces a mechanism by which a mobile device may disregard TCXOMGR RGS frequency information when specific conditions are met and then gradually escalate to larger frequency bins for system acquisition if the system cannot be acquired utilizing the initial smaller frequency bins.

Operation block 302 may include receiving frequency error values, e.g., RGS values, from the TCXOMGR. The frequency error values may include a seed frequency and an uncertainty value for that seed frequency. With respect to FIG. 2, the processor 204 with or without the memory 206, for example, may provide the TCXOMGR functionality within a mobile device, such as the STA 106 of FIG. 1.

Operation block 304 may include defining a size of a frequency bin for a first radio access technology (RAT) based on a frequency error for a second radio access technology. For example, the processor 204 of FIG. 2 may utilize the received seed frequency and uncertainty value to determine a size of frequency bins that will be used to acquire system access with the first RAT.

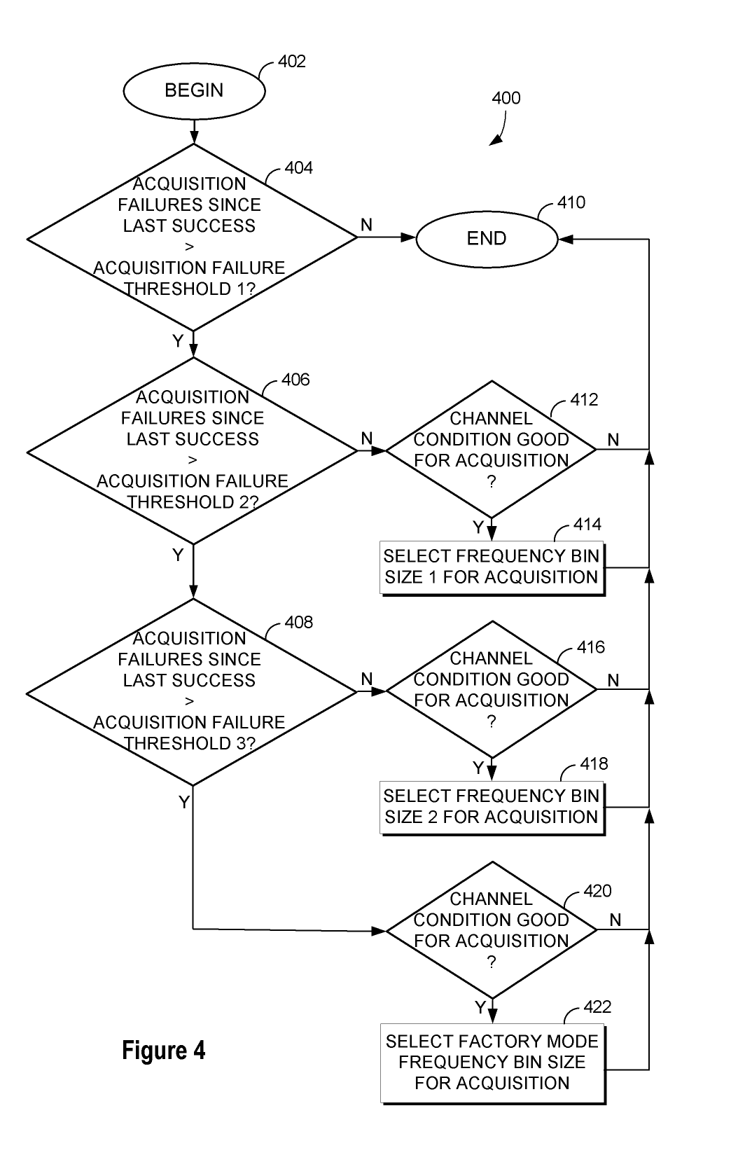

Operation block 306 may include attempting system acquisition. For example, the processor 204 of FIG. 2 may attempt to acquire the system by sequentially searching within frequency bins having a size as defined in operation block 304. If the system is acquired utilizing the frequency bins as defined in operation block 304 the mobile device, for example, wireless device 202 of FIG. 2, may move to idle at operation block 310. However, if the system is not acquirable utilizing the frequency bins as defined in operation block 304, the method may move to operation block 312, which will be described in detail with respect to FIG. 4. Thus, where the method moves to operation block 312, a determination may be made that the signal is not acquirable using the defined size.

FIG. 4 is another flowchart of an aspect of the exemplary method of FIG. 3 for acquiring a signal, according to one implementation. As stated above in connection with FIG. 3, in some implementations, one or more of the blocks in flowchart 400 may be performed by, or in connection with, a processor, such as the processor 204 of FIG. 2, although those having ordinary skill in the art will appreciate that other components may be used to implement one or more of the blocks described herein. Although blocks may be described as occurring in a certain order, the blocks can be reordered, blocks can be omitted, and/or additional blocks can be added.

The method of FIG. 3 may continue at the begin block 402. The method may then move to operation block 404, which includes determining whether a number of acquisition failures since the last acquisition success is greater than a first acquisition failure threshold. Such a first acquisition failure threshold may be chosen base on historic data, such that threshold is large enough to include most or all of the channels but not too large that unnecessary acquisition attempts are performed using the frequency bin size defined in operation block 304 of FIG. 3. If the number of acquisition failures since the last acquisition success is not greater than the first acquisition failure threshold, the method may continue to end block 410. For the purpose of clarification, going forward any point where an operational block proceeds to end block 410 may be understood to continue back to the system acquisition block 306 of FIG. 3, where the mobile device may again attempt to acquire the system. However, turning back to operation block 404, if the number of acquisition failures since the last acquisition success is greater than the first acquisition failure threshold the method may continue to operation block 406.

Operation block 406 includes determining whether a number of acquisition failures since the last acquisition success is greater than a second acquisition failure threshold. If the number of acquisition failures since the last acquisition success is not greater than the second acquisition failure threshold, the method may continue to operation block 412. Operation block 412 includes determining whether the channel condition is good for acquisition. For example, empty channels may be filtered out while searching for energy in larger bins so that a particular RAT does not waste time in scanning empty channels. For such determination, a receive automatic gain control (RxAGC) threshold may be utilized. If the channel condition is not good for acquisition, e.g., the channel energy does not reach or exceed the RxAGC threshold, the method may progress to end block 410. However, if the channel condition is good for acquisition, the method may instead progress to operation block 414 where a first frequency bin size for acquisition may be selected. In some implementations, the first frequency bin size may encompass the seed frequency of the RGS information and 3 parts per million (ppm) variance on either side of the seed frequency. For example, if the seed frequency was 100 MHz the frequency bins may include 100 MHz and 3 ppm or less error in either direction from 100 MHz, e.g., 100 MHz±300 Hz or a 600 Hz bandwidth. The method may then progress to end block 410.

Returning to operation block 406, if the number of acquisition failures since the last acquisition success is greater than the second acquisition failure threshold, the method may continue to operation block 408. Operation block 408 includes determining whether a number of acquisition failures since the last acquisition success is greater than a third acquisition failure threshold. If the number of acquisition failures since the last acquisition success is not greater than the third acquisition failure threshold, the method may continue to operation block 416. Operation block 416, like operation block 412, includes determining whether the channel condition is good for acquisition. If the channel condition is not good for acquisition, the method may progress to end block 410. However, if the channel condition is good for acquisition, the method may instead progress to operation block 418 where a second frequency bin size for acquisition may be selected. The second frequency bin size may be larger than the first frequency bin size. In some implementations, the second frequency bin size may be determined based on a “fallback RGS” value. Such a “fallback RGS” value may be a temperature variation compensated copy of the last known good RGS used by the requesting RAT. For example, the mobile device may save the last known (or most recently received) good RGS used by each type of RAT and store it in a memory, for example memory 206 of wireless device 202 shown in FIG. 2. This value may then be recalled as the “fallback RGS” for the particular type of RAT when the number of acquisition failures since a last acquisition success has exceeded the second acquisition failure threshold. In some implementations, the second frequency bin size may encompass the seed frequency of the “fallback RGS” information and 25 parts per million (ppm) variance on either side of the seed frequency. For example, if the “fallback RGS” information had a seed frequency of 100 MHz the second frequency bins may include 100 MHz and 25 ppm or less error in either direction from 100 MHz, e.g., 100 MHz±2.5 kHz or a 5 kHz bandwidth. The method may then progress to end block 410.

Returning to operation block 408, if the number of acquisition failures since the last acquisition success is greater than the third acquisition failure threshold, the method may continue to operation block 420. Operation block 420, like operation blocks 412 and 416, includes determining whether the channel condition is good for acquisition. If the channel condition is not good for acquisition, the method may progress to end block 410. However, if the channel condition is good for acquisition, the method may instead progress to operation block 422 where a third frequency bin size (or “factory mode” frequency bin size) for acquisition may be selected. The third or “factory mode” frequency bin size may be larger than both of the first and second frequency bin sizes. In some implementations, the third frequency bin size may include the seed frequency and 56 parts per million (ppm) variance on either side of the seed frequency. For example, if the RGS information had a seed frequency of 100 MHz the third frequency bins may include 100 MHz and 56 ppm or less error in either direction from 100 MHz, e.g., 100 MHZ±5.6 kHz or a 11.2 kHz bandwidth. The method may then progress to end block 410.

Thus the size of the frequency bins are adjusted based on determining that the signal is not acquirable using the pre-defined bin size, as in any of operation blocks 404, 406 or 408. In addition, where the “fallback RGS” or “factory mode” settings are utilized, the method allows for disregarding the actual RGS information received from the TCXOMGR in favor of the “fallback RGS” and/or “factory mode” information.

In this way, gradual escalation to larger frequency bins is only utilized when the smaller frequency bins are insufficient to acquire the system, thus both increasing the likelihood of system acquisition while simultaneously limiting the increase in the average length of time required to acquire the system inherent in utilizing larger frequency bins.

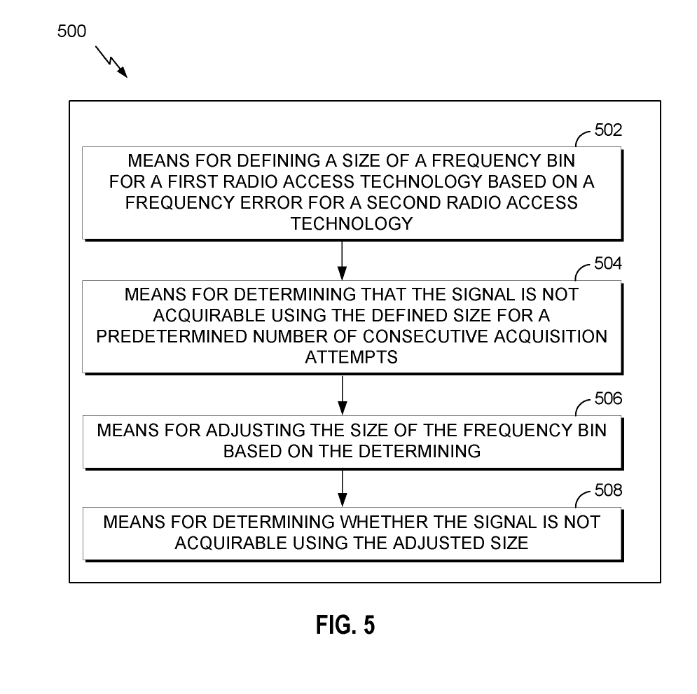

FIG. 5 is a functional block diagram of an exemplary apparatus for wireless communication, according to another implementation. Those skilled in the art will appreciate that the apparatus may have more components than illustrated in FIG. 5. The apparatus 500 includes only those components useful for describing some prominent features of implementations within the scope of the claims. In one implementation, the apparatus 500 is configured to perform the method 300/400 shown above in FIGS. 3 and 4. The apparatus 500 may comprise the STA 106 shown in FIG. 1, for example, which may be shown in more detail as the wireless device 202 shown in FIG. 2.

The apparatus 500 comprises means 502 for defining a size of a frequency bin for a first radio access technology based on a frequency error for a second radio access technology. In some implementations, the means 502 can be configured to perform one or more of the functions described above with respect to block 304 of FIG. 3. The means 502 may comprise at least the processor 204 shown in FIG. 2, for example.

The apparatus 500 may further include means 504 for determining that the signal is not acquirable using the defined size for a predetermined number of consecutive acquisition attempts. In some implementations, the means 504 can be configured to perform one or more of the functions described above with respect to blocks 308 of FIG. 3. The means 504 may comprise at least the processor 204 shown in FIG. 2, for example.

The apparatus 500 may further include means 506 for adjusting the size of the frequency bin based on the determining. In some implementations, the means 506 can be configured to perform one or more of the functions described above with respect to any of blocks 414, 418 and 422 of FIG. 4 as well as any required blocks in the flow path of blocks 414, 418, and 422. The means 506 may comprise at least the processor 204 shown in FIG. 2, for example.

The apparatus 500 may further include means 508 for determining whether the signal is not acquirable using the adjusted size. In some implementations, the means 508 can be configured to perform one or more of the functions described above with respect to blocks 306 and 308 of FIG. 3 after having passed through at least one of blocks 414, 418 or 422 and end block 410 of FIG. 4. The means 508 may comprise at least the processor 204 shown in FIG. 2, for example.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more blocks or actions for achieving the described method. The method blocks and/or actions may be interchanged with one another without departing from the scope of the claims. In other words, unless a specific order of blocks or actions is specified, the order and/or use of specific blocks and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method of acquiring a signal, comprising:
defining a size of a frequency bin for a first radio access technology based on a frequency error for a second radio access technology;
determining that the signal is not acquirable using the defined size for a predetermined number of consecutive acquisition attempts;
adjusting the size of the frequency bin based on the determining; and
determining whether the signal is not acquirable using the adjusted size.

2. The method of claim 1, further comprising identifying the frequency error for the second radio access technology.

3. The method of claim 1, wherein the adjusting the size of the frequency bin comprises disregarding the frequency error for the second radio access technology.

4. The method of claim 1, wherein the frequency error for the second radio access technology comprises a most recently received frequency error for the second radio access technology.

5. The method of claim 1, wherein the adjusting the size of the frequency bin is based on a most recently received frequency error for the first radio access technology.

6. The method of claim 5, further comprising compensating the most recently received frequency error for temperature variation.

7. The method of claim 1, wherein the frequency error for the second radio access technology comprises a seed frequency value and a frequency uncertainty value.

8. The method of claim 1, further comprising determining whether a channel energy associated with the frequency bin is greater than a predetermined level.

9. An apparatus for wireless communication, comprising:
a processor configured to:
define a size of a frequency bin for a first radio access technology based on a frequency error for a second radio access technology;
determine that the signal is not acquirable using the defined size for a predetermined number of consecutive acquisition attempts;
adjust the size of the frequency bin based on the determining; and
determine whether the signal is not acquirable using the adjusted size.

10. The apparatus of claim 9, wherein the processor is further configured to identify the frequency error for the second radio access technology.

11. The apparatus of claim 9, wherein the adjusting the size of the frequency bin comprises disregarding the frequency error for the second radio access technology.

12. The apparatus of claim 9, wherein the frequency error for the second radio access technology comprises a most recently received frequency error for the second radio access technology.

13. The apparatus of claim 9, wherein the adjusting the size of the frequency bin is based on a most recently received frequency error for the first radio access technology.

14. The apparatus of claim 13, wherein the processor is further configured to compensate the most recently received frequency error for temperature variation.

15. The apparatus of claim 9, wherein the determining that the signal is not acquirable is based on a predetermined number of consecutive acquisition failures.

16. The apparatus of claim 9, wherein the frequency error for the second radio access technology comprises a seed frequency value and a frequency uncertainty value.

17. A non-transitory computer-readable medium comprising code that, when executed, causes a processor to:
define a size of a frequency bin for a first radio access technology based on a frequency error for a second radio access technology;
determine that the signal is not acquirable using the defined size for a predetermined number of consecutive acquisition attempts;
adjust the size of the frequency bin based on the determining; and
determine whether the signal is not acquirable using the adjusted size.

18. The medium of claim 17, further comprising code that, when executed, causes the processor to identify the frequency error for the second radio access technology.

19. The medium of claim 17, wherein the adjusting the size of the frequency bin comprises disregarding the frequency error for the second radio access technology.

20. The medium of claim 17, wherein the frequency error for the second radio access technology comprises a most recently received frequency error for the second radio access technology.

21. The medium of claim 17, wherein the adjusting the size of the frequency bin is based on a most recently received frequency error for the first radio access technology.

22. The medium of claim 21, further comprising code that, when executed, causes the processor to compensate the most recently received frequency error for temperature variation.

23. The medium of claim 17, wherein the frequency error for the second radio access technology comprises a seed frequency value and a frequency uncertainty value.

24. An apparatus for wireless communication, comprising:
means for defining a size of a frequency bin for a acquiring first radio access technology based on a frequency error for a second radio access technology;
means for determining that the signal is not acquirable using the defined size for a predetermined number of consecutive acquisition attempts;
means for adjusting the size of the frequency bin based on the determining; and
means for determining whether the signal is not acquirable using the adjusted size.

25. The apparatus of claim 24, further comprising means for identifying the frequency error for the second radio access technology.

26. The apparatus of claim 24, wherein the means for adjusting the size of the frequency bin disregards the frequency error for the second radio access technology when adjusting the size of the frequency bin.

27. The apparatus of claim 24, wherein the frequency error for the second radio access technology comprises a most recently received frequency error for the second radio access technology.

28. The apparatus of claim 24, wherein the means for adjusting the size of the frequency bin adjusts the size of the frequency bin based on a most recently received frequency error for the first radio access technology.

29. The apparatus of claim 28, further comprising means for compensating the most recently received frequency error for temperature variation.

30. The apparatus of claim 24, wherein the frequency error for the second radio access technology comprises a seed frequency value and a frequency uncertainty value.
